(19) United States
(12) Patent Application Publication
(10) Pub. No.: US 2025/0266609 A1
(43) Pub. Date: Aug. 21, 2025

(54) MODULAR ANTENNA UNIT FOR CONSTRUCTING TAG READER PORTALS

(71) Applicants: RFIDKNOW LLC, Simpsonville, SC (US); INNOVOI OY / LTD, Siuro (FI)

(72) Inventors: Jeffrey Joseph Hoerl, Jr., Simpsonville, SC (US); Matti Ritamäki, Siuro (FI)

(21) Appl. No.: 19/056,635

(22) Filed: Feb. 18, 2025

Related U.S. Application Data
(60) Provisional application No. 63/554,221, filed on Feb. 16, 2024.

(51) Int. Cl. H01Q 1/22; G06K 7/10

(52) U.S. Cl. CPC H01Q 1/2216; G06K 7/10297

(57) ABSTRACT

A modular antenna unit configured to read radio frequency tags is configured to be used as a building block component for constructing a larger tag reader portal. The modular antenna unit may include a housing, an antenna affixed within the housing, a reader mounting interface, and a universal mounting interface. The universal mounting interface may be configured to permit the modular antenna unit to be mounted in the plurality of mounting configurations to allow an antenna read zone of the antenna to combine with a supplemental antenna read zone of a supplemental modular antenna unit to generate one of a plurality of different configurable portal read zones for a tag reader portal.

### CROSS-REFERENCE TO RELATED APPLICATIONS

This application claims the benefit of U.S. Provisional Application No. 63/554,221 filed on Feb. 16, 2024, the entire contents of which are hereby incorporated herein by reference.

### TECHNICAL FIELD

Example embodiments generally relate to tag reader technology and more specifically to the construction of tag reader portals that include a plurality of antennas.

### BACKGROUND

Wireless tagging technology has proven to be useful a variety of contexts. For example, tags, such as radio frequency identification (RFID) tags can be affixed to almost any object that a user may wish to track. Some implementations involve the use of RFID tag reading portals that read the RFID tags affixed to objects as the objects pass through the portals. Such a tag reader portal may be implemented at a shipping doorway of a retail distribution center to track the tagged products leaving the facility. Tag reader portals may be implemented by parcel delivery services to track the progress of a package through the parcel service's transportation system.

Although such tag reader portals are in use today, there continues to be challenges with the implementation of such portals. For example, tag reader portals often involve custom designs for a specific implementation and location for the portal. Further, such portals are large and unwieldy making the portal difficult to transport and install. Due to the non-standard, custom designs, maintenance and replacement of components of conventional tag reader portals is cumbersome and difficult to perform.

### BRIEF SUMMARY OF SOME EXAMPLES

A modular antenna unit is described according to some example embodiments. The modular antenna unit may be configured to read radio frequency tags, and the modular antenna unit may comprise a housing, an antenna, a reader mounting interface, and a universal mounting interface. The housing may comprise an antenna compartment and a reader compartment. The antenna may be affixed within the antenna compartment, and the antenna may have an antenna read zone. The reader mounting interface may be disposed within the reader compartment and may be configured to secure a reader to the housing within the reader compartment for the reader to be connected to the antenna. The universal mounting interface may be configured to mount the modular antenna unit in one of a plurality of mounting configurations. The plurality of mounting configurations may comprise a floor mount configuration, a pole mount configuration, a hang mount configuration, and a stacked configuration. The universal mounting interface may be configured to permit the modular antenna unit to be mounted in the plurality of mounting configurations to allow the antenna read zone to combine with a supplemental antenna read zone of a supplemental modular antenna unit to generate one of a plurality of different configurable portal read zones for a tag reader portal.

According to some example embodiments, a tag reader portal having a defined portal read zone is described. The tag reader portal may comprise a first modular antenna unit and a second modular antenna unit. The first modular antenna unit may comprise first antenna and a first universal mounting interface. The first antenna may have a first antenna read zone. The second modular antenna unit may comprise a second antenna and a second universal mounting interface. The second antenna may have a second antenna read zone. The first modular antenna unit and the second modular antenna unit may be manufactured to be substantially structurally identical as interchangeable modules. The first universal mounting interface may be configured to mount the first modular antenna unit in one of a plurality of mounting configurations. The plurality of mounting configurations may comprise a floor mount configuration, a pole mount configuration, a hang mount configuration, and a stacked configuration. The first modular antenna unit may be mounted in a first mounting configuration that is one of the plurality of mounting configurations. The second universal mounting interface may be configured to mount the second modular antenna unit in one of the plurality of mounting configurations. The second modular antenna unit may be mounted in a second mounting configuration that is one of the plurality of mounting configurations. The first mounting configuration may be different from the second mounting configuration.

According to some example embodiments, a method for constructing a tag reader portal with a plurality of modular antenna units is provided. In this regard, the plurality of modular antenna units may comprise a first modular antenna unit and a second modular antenna unit. The first modular antenna unit and the second modular antenna unit may be manufactured to be substantially structurally identical as interchangeable modules. The method may comprise mounting the first modular antenna unit via a first universal mounting interface of the first modular antenna unit in a first mounting configuration. The first modular antenna unit may comprise a first antenna having a first antenna read zone. The method may also comprise mounting the second modular antenna unit via a second universal mounting interface of the second modular antenna unit in a second mounting configuration. The second modular antenna unit may comprise a second antenna having a second antenna read zone. The first antenna read zone and the second antenna read zone may combine to generate one of a plurality of different configurable portal read zones based on positioning and mounting configurations of the first modular antenna unit and the second modular antenna unit.

### BRIEF DESCRIPTION OF THE SEVERAL VIEWS OF THE DRAWING(S)

Having thus described some embodiments in general terms, reference will now be made to the accompanying drawings, which are not necessarily drawn to scale, and wherein:

FIG. 1A illustrates an example modular antenna unit according to some example embodiments;

FIG. 1B illustrates a modular antenna unit and a field of an antenna of a modular antenna unit according to some example embodiments;

FIG. 1C illustrates a modular antenna unit and a field of an antenna of a modular antenna unit according to some example embodiments;

FIGS. 2A, 2B, 3, 4, 5, 6, and 7 illustrate various example tag reader portals constructed using one or more modular antenna units according to some example embodiments;

FIG. 8A illustrates a front of an example modular antenna unit according to some example embodiments;

FIG. 8B illustrates a back of an example modular antenna unit according to some example embodiments;

FIG. 8C illustrates a cross-section side view an example modular antenna unit according to some example embodiments;

FIG. 8D illustrates an example reader plate according to some example embodiments;

FIGS. 9A to 9E illustrate steps in a reader installation process according to some example embodiments;

FIG. 10 illustrates a component of a universal mounting interface according to some example embodiments;

FIGS. 11 to 14 illustrate various mounting assemblies for mounting a modular antenna unit in respective mounting configurations according to some example embodiments; and

FIG. 15 illustrates a flowchart of a method for constructing a tag reader portal according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

According to some example embodiments, a modular antenna unit for use in constructing a tag reader portal is described. As mentioned above, a technical problem with the design and construction of tag reader portals is that such portals often involve custom designs and construction. In instances where such conventional tag reader portals are constructed off-site, the transportation and installation of the tag reader portal can be difficult and raise many complexities. To address these and other technical problems, a modular antenna unit has been developed, according to some example embodiments, that is configurable into a number of different mounting and connectivity configurations for use in constructing a tag reader portal with a tailored portal read zone. In this regard, according to some example embodiments, modular antenna units may be manufactured to be substantially structurally identical as interchangeable modules that can be used as agnostic building blocks of a tag reader portal. According to some example embodiments, the modular antenna units may be light weight (e.g., less than 20 pounds) and have a maximum size dimension (e.g., a length) of less than 40 inches. Such weight and size limitations allow for extreme convenience for shipping and installing. With respect to shipping, common parcel carriers may be utilized for deliveries, greatly reducing the aggregate cost of shipping a tag reader portal relative to conventional approaches as mentioned above. Additionally, because the modular antenna unit weight is low, construction of the tag reader portal can require less installation equipment (e.g., cranes, lifts, and the like). Additionally, injuries that might result from lifting and working with heavier components and solutions can be reduced or eliminated.

As a modular device, the modular antenna unit, according to some example embodiments, may be mounted in a number of different configuration based on the particular application and environment. In this regard, the same modular antenna unit may be mounted in, for example, a floor mount configuration, a pole mount configuration, a hang mount configuration, a stacked configuration, and in other mounting configurations. Such flexibility for mounting can allow for “on the fly” design changes when constructing a tag reader portal due to unexpected environment conditions (e.g., an unsuitable initial mounting conditions that were not revealed until on-site construction began). Additionally, the modular antenna units may be affixed to each other in a stacked configuration, and the stacked assembly may be mounted in a number of different configurations. One particularly useful configuration is a stacked, floor mounted (e.g., pedestal) configuration that can be placed on both sides of a doorway to generate portal read zone to read tags passing through the doorway. Alternatively, stacked configurations may be wall mounted, pole mounted, or hang mounted. Such variety of mounting configurations, according to some example embodiments, allows for an ability to design a desired portal read zone through the placement and control of the modular antenna units, without the need for custom structural designs.

Moreover, according to some example embodiments, each modular antenna unit may be configured to secure a reader within the modular antenna unit's housing. As such, a given modular antenna unit may be reader unit or may be connected to a reader unit. In other words, since a reader may be configured to control a number of antenna units, the modular antenna units may be designed to operate with an on-board reader or connect to a reader that is installed in another modular antenna unit. Again, such configurable placement of a reader within any one of the modular antenna units of a tag reader portal design allows for further flexibility and ease of construction.

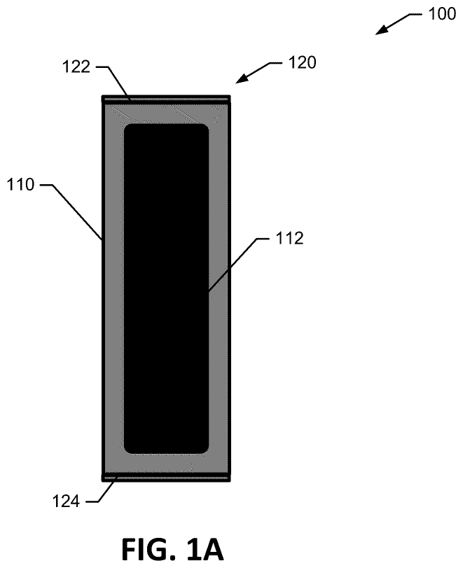

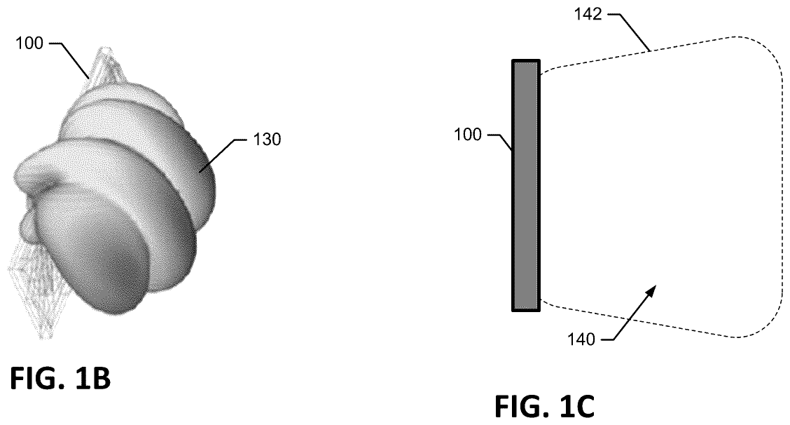

Referring now to FIG. 1, an example modular antenna unit 100, according to some example embodiments. More specifically, a front view of the modular antenna unit 100 is shown. In this view, the external housing 110, an antenna screen 112, and a universal mounting interface 120. According to some example embodiments, the housing 110 may be formed of a robust material, such as a metal, to provide durability to the modular antenna unit 100. In situations where the housing 110 is made of metal, the housing may affect the field generated by the internal antenna. As such, the front of the housing 110 may include an opening. However, so that the internal antenna is still protected from the external environment, the housing 110 may include a field permeable antenna screen 112. The antenna screen 112 may be formed of a material that protects the internal antenna, but still permits an electromagnetic field to emanate from the housing 110.

According to some example embodiments, the universal mounting interface 120 may embodied in a number of different ways. For example, the universal mounting interface 120 may include elements, i.e., mounting interface elements, that are disposed on various external surfaces of the housing 110. According to some example embodiments, the mounting interface elements may be posts, protrusions, openings, holes, to the like that are disposed on a surface of the housing 110 and facilitate mounting of the modular antenna unit 100 in one of a variety of mounting configurations as described herein. According to some example embodiments, the universal mounting interface 120 may include mounting interface elements on a top surface 122 of the housing 110 and a bottom surface 124 of the housing 110. While example embodiments shown in the figures illustrate implementations where the mounting interface elements are disposed on the top surface 122 and the bottom surface 124, it is understood that other positioning and types of mounting interface elements may be used in according to some example embodiments.

Referring now to FIG. 1B, the modular antenna unit 100 is shown with a depiction of an example electromagnetic field 130 that may be generated by the antenna of the modular antenna unit 100. As can be seen, based on the controllable parameters (e.g., power, etc.), the field 130 forms a rather complex shape that is not readily defined. However, for purposed of explanation and understand, aspects of some of the example embodiments will be described with a simplified visualization of the field generated by an antenna of the modular antenna unit 100. As such, we reference to FIG. 1C, the modular antenna unit 100 is again shown with a simplified field that defines an antenna read zone 140 having a boundary 142. One of skill in the art would appreciate that no set boundary for the antenna read zone can be statically defined. However, again, for purposes of explanation, such an antenna read zone 140 will be referenced herein.

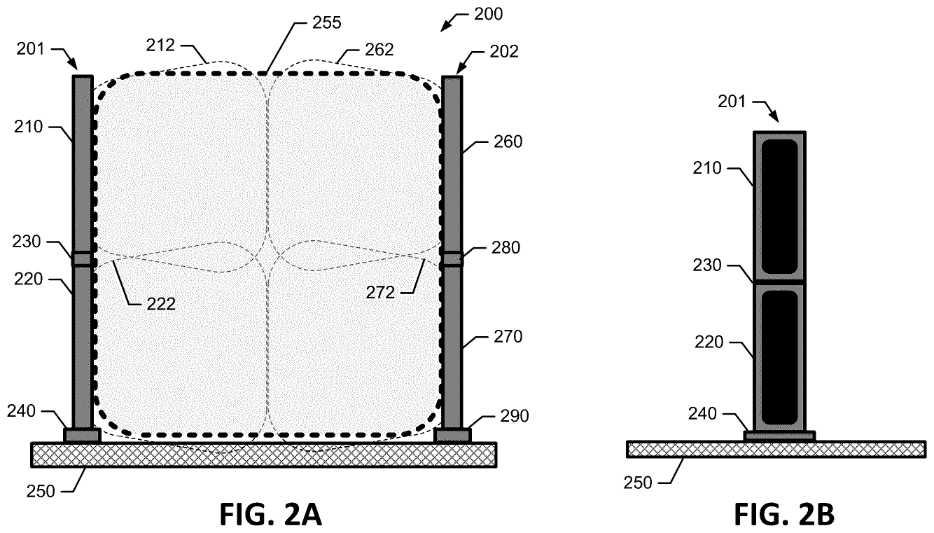

FIGS. 2A to 7 will now be described, which show various different constructions of tag reader portals using one or more modular antenna units and leveraging the modular aspects and configurable mounting. In this regard, the example tag reader portals illustrate that the same building block modular antenna unit can be used together with other modular antenna units to generate a portal read zone that is a combination of the antenna read zones of the antennas of the modular antenna units. Again, for simplicity, the antenna read zones are shown as being statically defined and unaffected by constructive and destructive field effects that would be present in a real-world implementation.

In this regard, FIG. 2 illustrates a self-supported pedestal tag reader portal 200. Such a tag reader portal 200 may be positioned at the ingress or egress of a space or building to track the entry or exit of tags and associated objects entering or exiting the space or building. The tag reader portal 200 may be comprised of a left tower 201 and a right tower 202. A front view of the left tower 201 is shown in FIG. 2B.

The left tower 201 may be comprised of a modular antenna unit 210 in a stacked configuration with a modular antenna unit 240 that is in a floor mount configuration. The modular antenna unit 220 may be affixed to the floor via a floor mounting assembly 240 that couples to a component of a universal mounting interface of the modular antenna unit 220 disposed on the bottom surface of the modular antenna unit 210. According to some example embodiments, the floor mounting assembly 240 may secure the modular antenna unit 220 to the floor 250 and also provide a leveling feature to secure the modular antenna unit 220 to the floor 250 in a level position. The antenna of the modular antenna unit 220 may generate an antenna read zone having a boundary 222.

The modular antenna unit 210 may be in a stacked configuration on the modular antenna unit 220. In this regard, a component of the universal mounting interface of the modular antenna unit 210 may be coupled to a component of the universal mounting interface of the modular antenna unit 220. More specifically, according to some example embodiments, the component of the universal mounting interface of the modular antenna unit 210 on the bottom of the modular antenna unit 210 may be coupled to the component of the universal mounting interface of the modular antenna unit 220 on the top of the modular antenna unit 220 via the stacked mounting assembly 230. The antenna of the modular antenna unit 210 may generate an antenna read zone having a boundary 212.

The right tower 202 may be comprised of a modular antenna unit 260 in a stacked configuration with a modular antenna unit 270 that is in a floor mount configuration. The modular antenna unit 270 may be affixed to the floor via a floor mounting assembly 290 that couples to a component of a universal mounting interface of the modular antenna unit 270 disposed on the bottom surface of the modular antenna unit 260. According to some example embodiments, the floor mounting assembly 290 may secure the modular antenna unit 270 to the floor 250 and also provide a leveling feature to secure the modular antenna unit 270 to the floor 250 in a level position. The antenna of the modular antenna unit 270 may generate an antenna read zone having a boundary 272.

The modular antenna unit 260 may be in a stacked configuration on the modular antenna unit 270. In this regard, a component of the universal mounting interface of the modular antenna unit 260 may be coupled to a component of the universal mounting interface of the modular antenna unit 270. More specifically, according to some example embodiments, the component of the universal mounting interface of the modular antenna unit 260 on the bottom of the modular antenna unit 260 may be coupled to the component of the universal mounting interface of the modular antenna unit 270 on the top of the modular antenna unit 220 via the stacked mounting assembly 280. The antenna of the modular antenna unit 260 may generate an antenna read zone having a boundary 262.

As shown, the design of the tag reader portal 200, constructed using the modular antenna units 210, 220, 260 and 270 may involve the respective fields of the modular antenna units 210, 220, 260 and 270 to be combined to define a portal read zone 255. The portal read zone 255 may be defined as an aggregate boundary for reading tags passing through the tag reader portal 200. Thus, the portal read zone 255 defines one example portal read zone that may be defined using the modular antenna units according to some example embodiments.

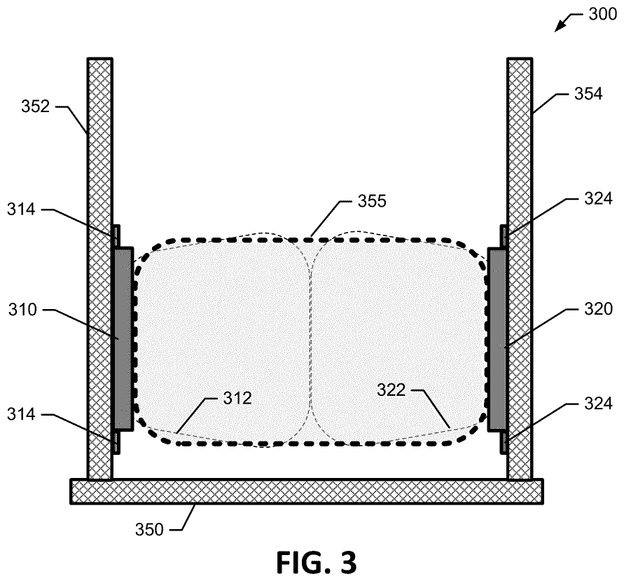

Now referring to FIG. 3, another tag reader portal 300 is shown according to some example embodiments. The tag reader portal 300 may comprise a modular antenna unit 310 and a modular antenna unit 320. The modular antenna units 310 and 320 may be in a wall mounted (e.g., flush wall mount) configuration. As such, the modular antenna unit 310 may be mounted to the wall 352 above the floor 350, and the modular antenna unit 320 may be mounted to the wall 354 above the floor 350. The universal mounting interface of the modular antenna unit 310 may couple with wall mounting assembly 314 to secure the modular antenna unit 310 to the wall 352. The universal mounting interface of the modular antenna unit 320 may couple with wall mounting assembly 324 to secure the modular antenna unit 320 to the wall 354.

The antenna of the modular antenna unit 310 may generate an antenna read zone having a boundary 312 and the modular antenna unit 320 may generate an antenna read zone having a boundary 322. As shown, the design of the tag reader portal 300, constructed using the modular antenna units 310 and 320 may involve the respective fields of the modular antenna units 310 and 320 to be combined to define a portal read zone 355. The portal read zone 355 may be defined as an aggregate boundary for reading tags passing through the tag reader portal 300. Thus, the portal read zone 355 defines one example portal read zone that may be defined using the modular antenna units according to some example embodiments.

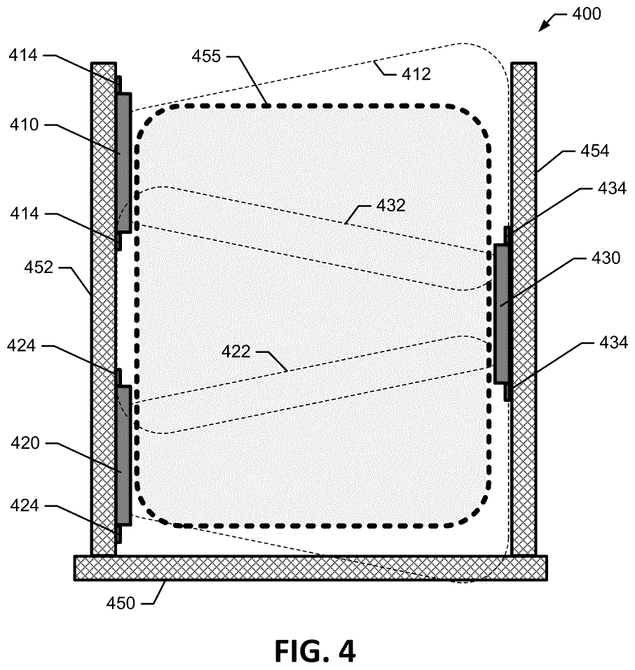

Now referring to FIG. 4 another tag reader portal 400 is shown according to some example embodiments. The tag reader portal 400 may comprise a modular antenna unit 410, a modular antenna unit 420, and a modular antenna unit 430. The modular antenna units 410, 420, and 430 may be in a wall mounted (e.g., flush wall mount) configuration. As such, the modular antenna unit 410 may be mounted to the wall 452 above the floor 450, the modular antenna unit 420 may be mounted to the wall 452 above the floor 450, and the modular antenna unit 430 may be mounted to the wall 454 above the floor 450. The universal mounting interface of the modular antenna unit 410 may couple with wall mounting assembly 414 to secure the modular antenna unit 410 to the wall 452. The universal mounting interface of the modular antenna unit 420 may couple with wall mounting assembly 424 to secure the modular antenna unit 420 to the wall 452 below the modular antenna unit 410. The universal mounting interface of the modular antenna unit 430 may couple with wall mounting assembly 434 to secure the modular antenna unit 430 to the wall 454.

The antenna of the modular antenna unit 410 may generate an antenna read zone having a boundary 412, the modular antenna unit 420 may generate an antenna read zone having a boundary 422, and the modular antenna unit 430 may generate an antenna read zone having a boundary 432. Relative to the antenna read zones of the tag reader portal 300, the antenna read zones of the antennas for modular antenna units 410, 420, and 430 are larger due to, for example, high power being provided to the antennas. As shown, the design of the tag reader portal 400, constructed using the modular antenna units 410, 420, and 430 may involve the respective fields of the modular antenna units 410, 420, and 430 to be combined to define a portal read zone 455. The portal read zone 455 may be defined as an aggregate boundary for reading tags passing through the tag reader portal 400. Thus, the portal read zone 455 defines one example portal read zone that may be defined using the modular antenna units according to some example embodiments.

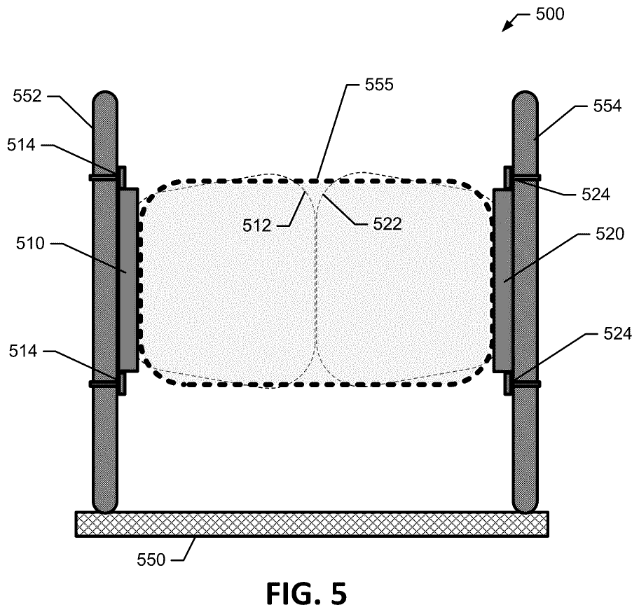

Now referring to FIG. 5, another tag reader portal 500 is shown according to some example embodiments. The tag reader portal 500 may comprise a modular antenna unit 510 and a modular antenna unit 520. The modular antenna units 510 and 520 may be in a pole mounted configuration. As such, the modular antenna unit 510 may be mounted to the pole 552 above the floor 550, and the modular antenna unit 520 may be mounted to the pole 554 above the floor 550. The universal mounting interface of the modular antenna unit 510 may couple with pole mounting assembly 514 to secure the modular antenna unit 510 to the pole 552. The universal mounting interface of the modular antenna unit 520 may couple with pole mounting assembly 524 to secure the modular antenna unit 520 to the pole 554.

The antenna of the modular antenna unit 510 may generate an antenna read zone having a boundary 512 and the modular antenna unit 520 may generate an antenna read zone having a boundary 522. As shown, the design of the tag reader portal 500, constructed using the modular antenna units 510 and 520 may involve the respective fields of the modular antenna units 510 and 520 to be combined to define a portal read zone 555. The portal read zone 555 may be defined as an aggregate boundary for reading tags passing through the tag reader portal 500. Thus, the portal read zone 555 defines one example portal read zone that may be defined using the modular antenna units according to some example embodiments.

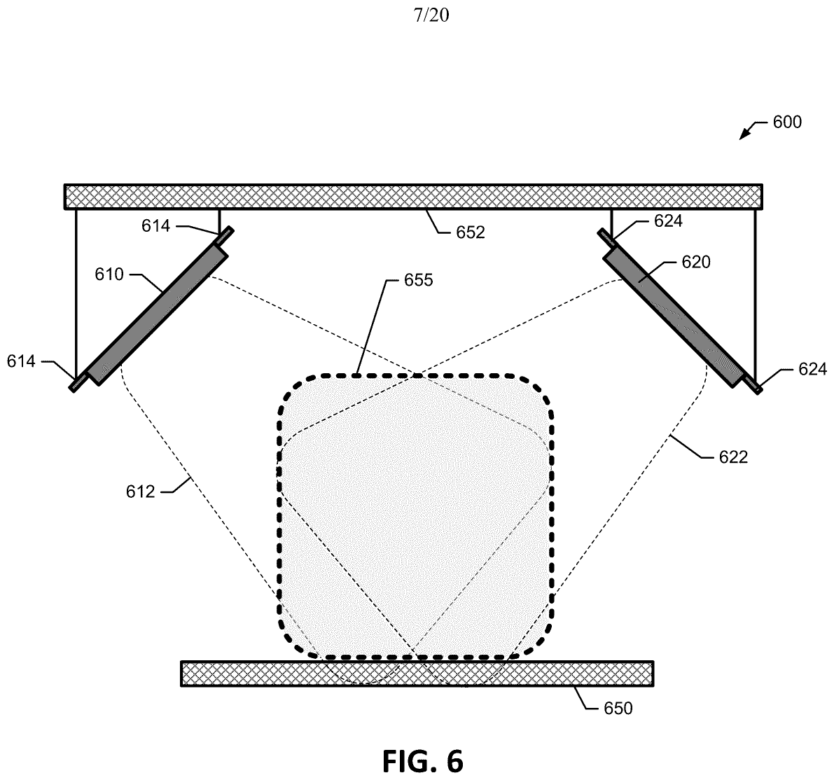

Now referring to FIG. 6, another tag reader portal 600 is shown according to some example embodiments. The tag reader portal 600 may comprise a modular antenna unit 610 and a modular antenna unit 620. The modular antenna units 610 and 620 may be in a hang mounted configuration. As such, the modular antenna unit 610 may be mounted to the ceiling 652 above the floor 650 via one or more tethers (e.g., chains, cables, or the like) via the hang mount assembly 614 interfacing with the universal mounting interface of the modular antenna unit 610. Similarly, the modular antenna unit 620 may be mounted to the ceiling 652 above the floor 650 via one or more tethers (e.g., chains, cables, or the like) via the hang mount assembly 624 interfacing with the universal mounting interface of the modular antenna unit 620.

The antenna of the modular antenna unit 610 may generate an antenna read zone having a boundary 612 and the modular antenna unit 620 may generate an antenna read zone having a boundary 622. As shown, the design of the tag reader portal 600, constructed using the modular antenna units 610 and 620, may involve the respective fields of the modular antenna units 610 and 620 to be combined to define a portal read zone 655. The portal read zone 655 may be defined as an aggregate boundary for reading tags passing through the tag reader portal 600. Thus, the portal read zone 655 defines one example portal read zone that may be defined using the modular antenna units according to some example embodiments.

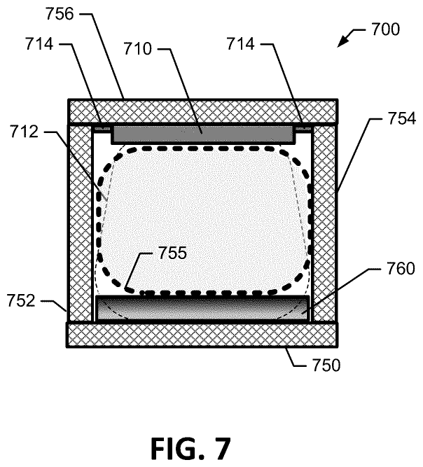

Now referring to FIG. 7, another tag reader portal 700 is shown according to some example embodiments. The tag reader portal 700 may be a conveyor belt portal with a conveyor 760 that moves tagged objects through the portal 700. As such, the tag reader portal 700 may comprise, for example, a modular antenna unit 710, as a lone modular antenna unit to form the tag reader portal 700. The modular antenna unit 710 may be ceiling mounted to the ceiling 756 via a ceiling mount assembly 714 that interfaces with the universal mounting interface of the modular antenna unit 710.

The antenna of the modular antenna unit 710 may generate an antenna read zone having a boundary 712. As shown, the design of the tag reader portal 700, constructed using the modular antenna unit 710, defines a portal read zone 755 based solely on the antenna read zone of the modular antenna unit 710. Thus, the portal read zone 755 defines one example portal read zone that may be defined using the modular antenna unit according to some example embodiments.

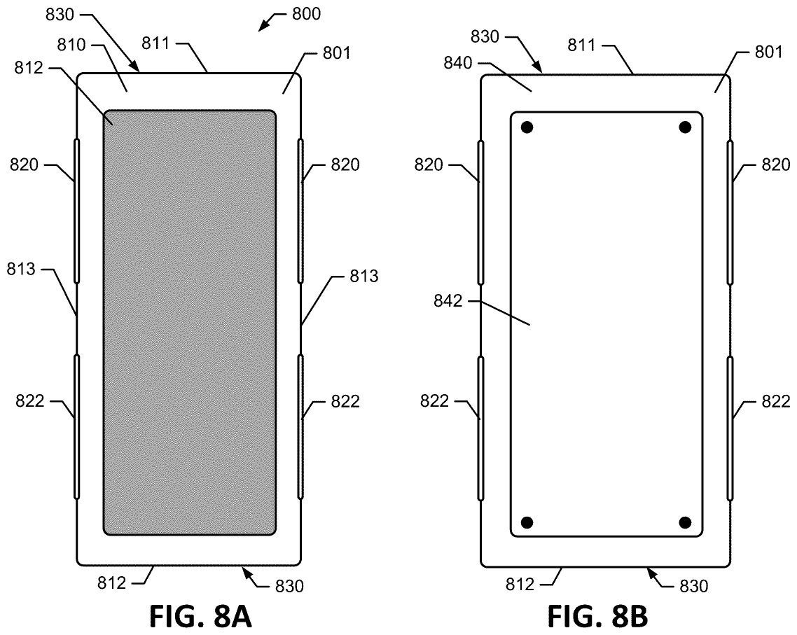

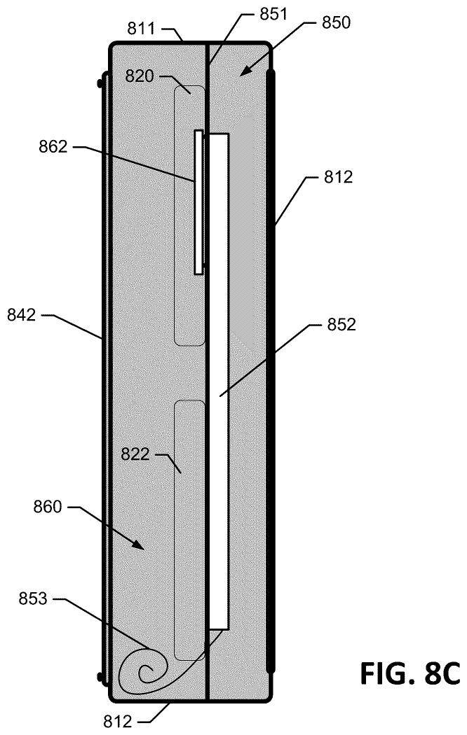

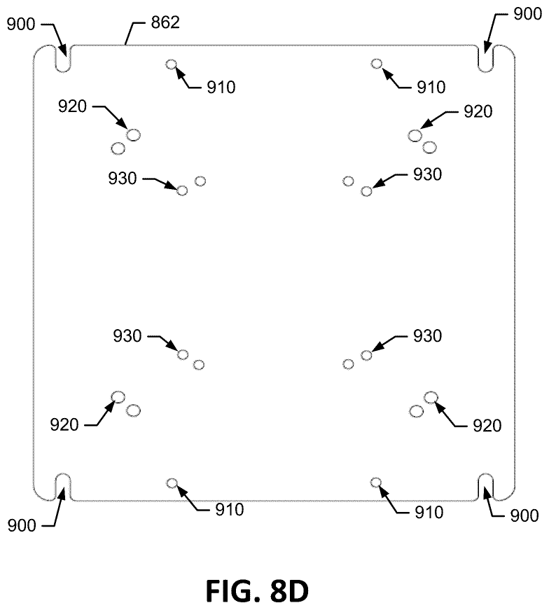

FIGS. 8A to 8D will now be described, which illustrate more detailed aspects of a modular antenna unit 800, according to some example embodiments. FIG. 8A provides a front view of the modular antenna unit 800 and FIG. 8B provides a back view of the modular antenna unit 800. The housing 801 may be same or similar to the housing 110 with respect to function and structure. The housing 801 may be an external support structure for the modular antenna unit 800. The housing 801 may have a front 812, a back 840, a top 811, a bottom 812, and sides 813.

According to some example embodiments, the housing 801 may be formed of a robust material, such as a metal, to provide durability to the modular antenna unit 800. In situations where the housing 801 is made of metal, the housing may affect the field generated by the internal antenna. As such, the front 812 may include an opening. However, so that the internal antenna is still protected from the external environment, the housing 801 may include a field permeable antenna screen 812. The antenna screen 812 may be formed of a material that protects the internal antenna, but still permits an electromagnetic field to emanate from the housing 801.

The sides 813 of the housing 801 may, according to some example embodiments, also include novel features. In this regard, each side 813 may include one or more openings that may be covered by removable side panels 820 and 822. Such removable side panels 820 and 822 may be removed to provide access to internal compartments (e.g., the reader compartment 860 of FIG. 8C). According to some example embodiments, since the back 840 of the housing 801 may abut a wall or ceiling surface thereby preventing access to the internal compartments when the modular antenna unit 800 is mounted in such configurations, the side panels 820 and 822 may provide convenient access to internal compartments even when the modular antenna unit 800 is mounted. In this regard, the back 840 may also include a large opening that may be covered by the removable rear panel 842.

According to some example embodiments, the modular antenna unit 800 also includes a universal mounting interface 830. The universal mounting interface 830 may include elements, i.e., mounting interface elements, that are disposed on various external surfaces of the housing 830. According to some example embodiments, the mounting interface elements may be posts, protrusions, openings, holes, to the like that are disposed on a surface of the housing 801 and facilitate mounting of the modular antenna unit 800 in one of a variety of mounting configurations as described herein. According to some example embodiments, the universal mounting interface 830 may include mounting interface elements on a top 811 and on the bottom 812 as further described below.

Now referring to FIG. 8C, a cross-section side view of the modular antenna unit 800 is shown. The modular antenna unit 800 and the housing 801 may comprise an antenna compartment 850 and a reader compartment 860. An antenna 852 may be disposed within the antenna compartment 850 and, according to some example embodiments, affixed to an internal wall 851 of the antenna compartment 850 that separates the antenna compartment 850 from the reader compartment 860. According to some example embodiments, the antenna compartment 850 may be sealed such that the antenna compartment 850 is not accessible without breaking a seal of the antenna compartment 850. As such, according to some example embodiments, a warranty for modular antenna unit 800 may be voided if the seal of the antenna compartment 850 is broken. The opening covered by the antenna screen 812 may cover a front of the modular antenna unit 800 as described above. Control and signal wiring 853 for the antenna 852 may pass through an opening in the wall 851 into the reader compartment 860 to allow the antenna 852 to be connected to a local or remote reader.

The reader compartment 860 may be a readily accessible compartment of the modular antenna unit 800 for securing a reader therein when the modular antenna unit 800 is operating as the reader head for a tag reader portal. In an instance where the modular antenna unit 800 is not operating as the reader head for a tag reader portal, the reader compartment 860 may remain empty. The reader compartment 860 may be accessible via a plurality of removable panels on the side and back of the housing 801. In this regard, the rear panel 842 may be removable to access the reader compartment 860 via a large rear opening. However, the size of the rear opening may be such that certain readers cannot be installed through the rear opening due to their size. As such, the side opening and removable side panel 820 and 822 may function to facilitate installation of a reader through the side openings. A reader may be installed on a removal reader plate 862 that is configured to readily couple to a reader and the wall 851 of the modular antenna unit 800.

Referring to FIG. 8D, an example reader plate 862 is shown. The reader plate 862 may include housing interface elements 900 (e.g., notches) for receiving a respective fastener to fasten the reader plate 862 to the wall 851. Additionally, the reader plate 862 may comprise a plurality of sets of reader interface elements (e.g., sets of holes or openings to receive respective fasteners). According to some example embodiments, each set of reader interface elements may be positioned to align with interface elements on a reader. In this regard, different brands of readers (e.g., Zebra FX9600, Impinj R700, Impinj R420, or the like) may be considered and a set of reader interface elements may be include for each respecting brand of reader. As such, the set of reader interface elements 910 may be configured to align with interface elements on a first brand of reader. The set of reader interface elements 920 may be configured to align with interface elements on a second brand of reader. The set of reader interface elements 930 may be configured to align with interface elements on a third brand of reader. As such, the reader plate 862 may be a universal reader interface that can be used with a variety of different brands of readers.

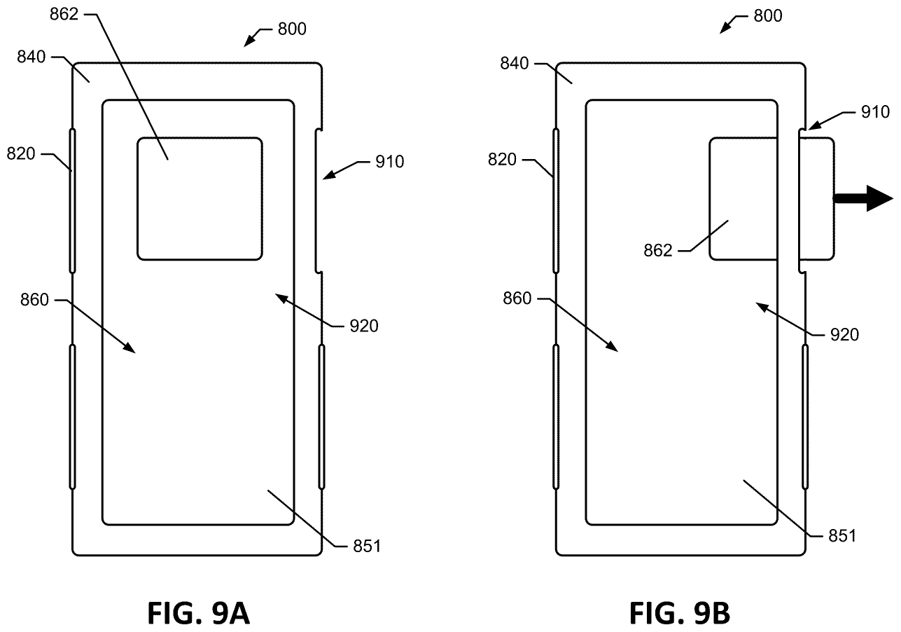

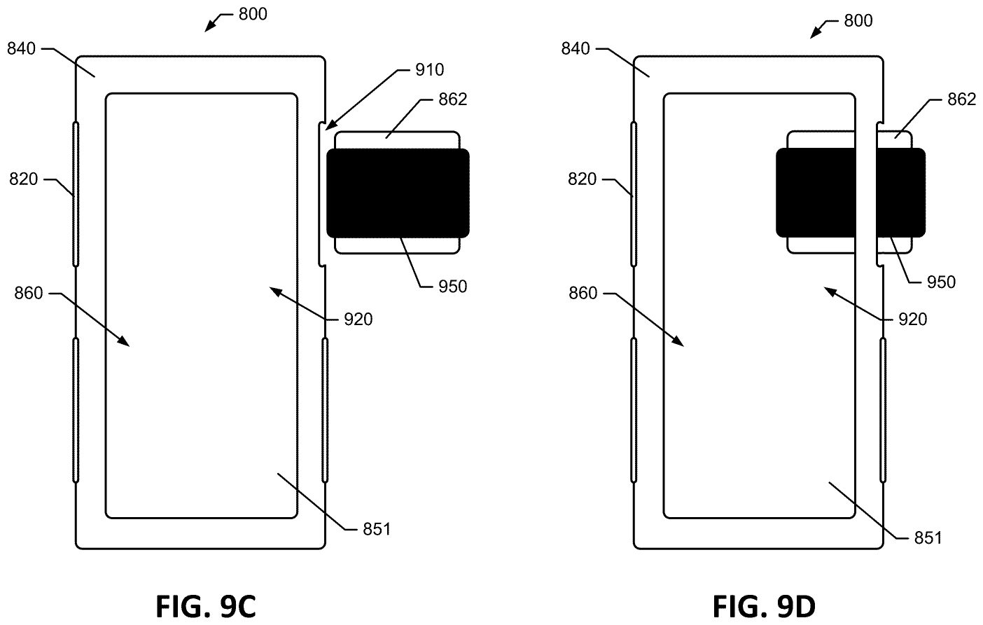

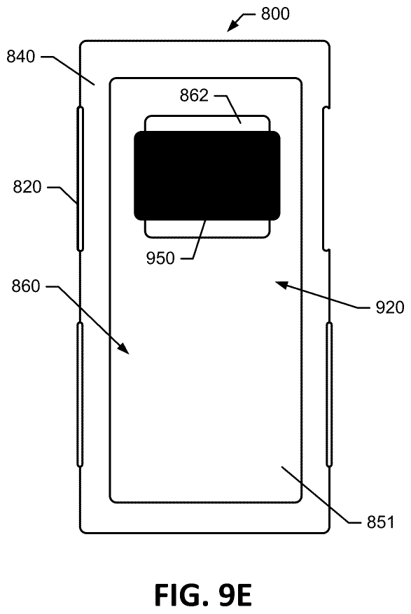

FIGS. 9A to 9E illustrate an example method for installing a reader into the modular antenna unit 800, according to some example embodiments. In this regard, FIG. 9A illustrates the back of the modular antenna unit 800 with the rear panel removed to reveal the reader plate 862. Additionally, a side opening 910 is present due to the respective side panel 820 being removed. In FIG. 9A, the reader plate 862 is secured in position on the wall 851. In FIG. 9B, the reader plate 862 has been detached from the wall 851 and is moved sideways as in the direction of the arrow out of the reader compartment 860 through the side opening 910.

Now referring to FIG. 9C, the reader plate 862 is completely removed from the housing 801 of the modular antenna unit 800. As such, a reader 950 may be readily affixed to the reader plate 862. As shown in FIG. 9D, the reader plate 862 with the reader 950 attached thereto may be moved back into the reader compartment 860 via the side opening 910 (possibly because the reader plate 862 with the reader 950 may be too large to pass through the rear opening 920. In FIG. 9E, the reader plate 862 with the reader 950 is now installed into the modular antenna unit 800 by affixing the reader plate 862 to the wall 851.

The use of the side opening 910 to facilitate installation or removal of a reader from the modular antenna unit 800 is an improvement over conventional installation approaches that, for example, only permit reader installation via a single access window. The use of the side opening greatly increases the installers ability to control the movement of the reader plate 862 and the reader 950 during installation and removal since a user's hand can hold the reader plate 862 by reaching into the side opening 910 while the reader plate 862 is detached to prevent the reader plate 862 from falling as it is detached and otherwise facilitate installation and removal.

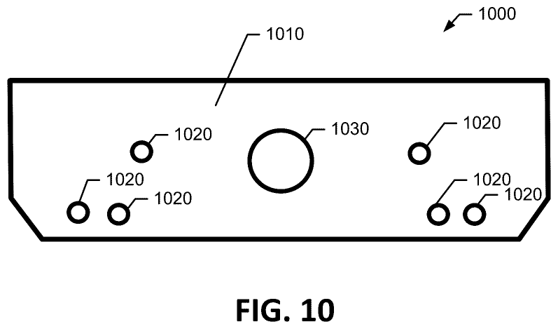

FIGS. 10 to 14 will now be described which illustrate various mounting assemblies that may be affixed to a universal mounting interface of a modular antenna unit to facilitate mounting in the various configurations provided herein. In this regard, FIG. 10 illustrates an example component 1000 of a universal mounting interface of a modular antenna unit. The component 1000 may be a surface 1010 that is a top or bottom surface of a housing of a modular antenna unit, according to some example embodiments. The component 1000 may include various mounting interface elements 1020 that are, for example, embodied as holes through which a fastener (e.g., a bolt) may pass to secure a mounting assembly to the component 1000. According to some example embodiments, the surface 1010 may also include a wiring passage 1030 through which wires may pass to connect, for example, an antenna of another modular antenna unit to a reader within a local modular antenna unit.

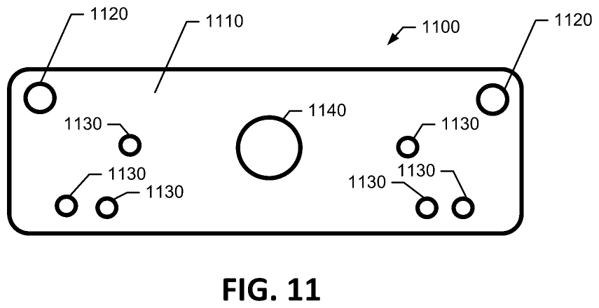

Referring to FIG. 11, a mounting assembly in the form of an example hanging mount 1100 is shown. The hanging mount 1100 may comprise a bracket 1110 that may be affixed to the component 1000 via the interface elements 1130 that are, for example, embodied as holes through which a fastener (e.g., a bolt) may pass to secure the hanging mount 1100 to the component 1000 at one end of a modular antenna unit. It is understood that another hanging mount 1100 may be secured to a second end of the modular antenna unit. The hanging mount 1100 may also include suspension features 1120 (e.g., holes) that may be configured to receive a tether (e.g., a chain, cable, or the like) to be secured to the hanging mount 1100 on one end and secured to, for example, a ceiling at the other end of the tether. According to some example embodiments, the hanging mount 1100 may also include a wiring passage 1140 that aligns with the wiring passage 1030 to allow wires to pass through.

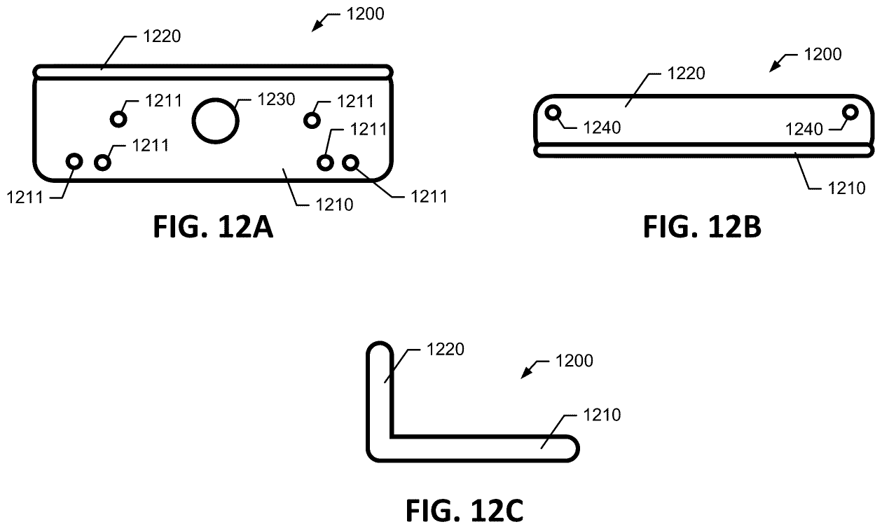

Referring to FIGS. 12A to 12C, a mounting assembly in the form of an example flush mount 1200 is shown. The flush mount 1200 may comprise an L-shaped bracket having a base 1210 and a surface securing extension 1220. The base 1210 may be affixed to the component 1000, while the surface securing extension 1220 may be secured to a wall or ceiling. In this regard, the base may be affixed to the component 1000 via the interface elements 1211 that are, for example, embodied as holes through which a fastener (e.g., a bolt) may pass to secure the base 1210 to the component 1000 at one end of a modular antenna unit. According to some example embodiments, the flush mount 1200 may also include a wiring passage 1230 that aligns with the wiring passage 1030 to allow wires to pass through. Additionally, the surface securing extension 1220 (which may be at a 90 degree angle to the base 1210) may include securing elements 1240 (e.g., holes through which fasteners may pass) to secure the flush mount 1200 to a ceiling or wall. Additionally, it is understood that another flush mount 1200 may be secured to a second end of the modular antenna unit.

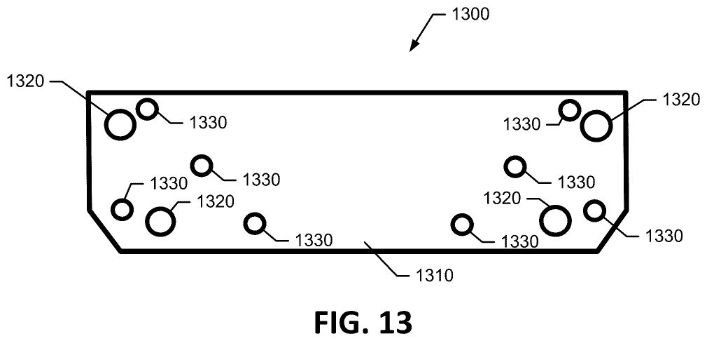

Referring to FIG. 13, a mounting assembly in the form of an example floor mount 1300 is shown. The floor mount 1300 may comprise a bracket 1310 that may be affixed to the component 1000 via the interface elements 1330 that are, for example, embodied as holes through which a fastener (e.g., a bolt) may pass to secure the floor mount 1300 to the component 1000 at one end of a modular antenna unit. The floor mount 1300 may also include leveling features 1120 (e.g., holes) that may be configured to receive a leveling screw that may be extended to different length to achieve a level orientation for the modular antenna unit attached thereto.

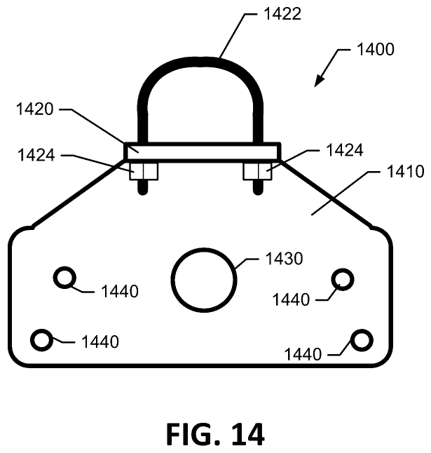

Referring to FIG. 14, a mounting assembly in the form of an example pole mount 1400 is shown. The pole mount 1400 may comprise an L-shaped bracket having a base 1410 and a pole securing extension 1420. The base 1410 may be affixed to the component 1000, while the pole securing extension 1420 may be secured to a pole by placing the U-bolt 1422 around the pole and securing the U-bolt 1422 to the pole securing extension 1420 with the nuts 1424. The base 1410 may be affixed to the component 1000 via the interface elements 1440 that are, for example, embodied as holes through which a fastener (e.g., a bolt) may pass to secure the base 1410 to the component 1000 at one end of a modular antenna unit. According to some example embodiments, the pole mount 1400 may also include a wiring passage 1430 that aligns with the wiring passage 1030 to allow wires to pass through. Additionally, it is understood that another flush mount 1200 may be secured to a second end of the modular antenna unit.

According to some example embodiments, a modular antenna unit may be smaller in size and light weight to be suitable for multiple mounting options including wall mounting, pole mounting, chain mounting, etc. in addition to stacking with floor mounts. As described above, several mounting assemblies in the form of mounting brackets may be used. Because of the modular nature and flexibility of use in constructing tag reader portals, modular antenna units may be kept in inventory to address a wide variety of implementations with speed to delivery. According to some example embodiments, for implementations that involve half pallet or conveyor reading zones, a single height thirty-eight inch modular antenna unit may be used. Additionally, the accessibility offered by the rear and side panel openings can reduce the need to use ladders and other equipment for construction and installation, thereby avoiding the associated risks. Additionally, according to some example embodiments, due to the modular nature of the modular antenna units, a failure of a single unit may merely involve replacement of the single unit, which is readily accomplished. Further, according to some example embodiments, the use of such modular antenna units supports standardization of tag reader portal to reduce product variants and enable keeping common stock independent of mounting methods.

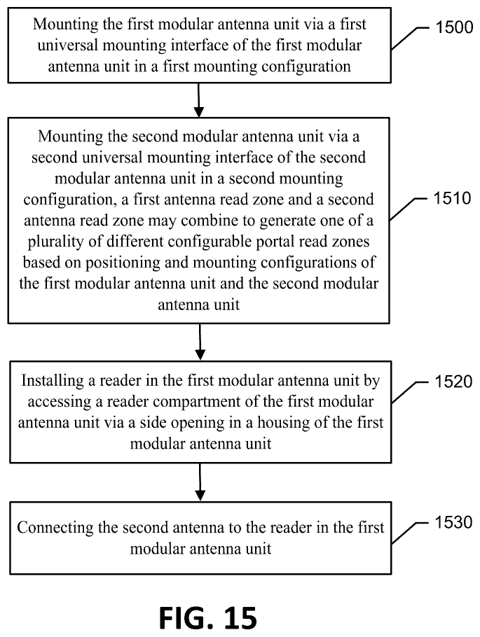

Now referring to FIG. 15, a flowchart of an example method for constructing a tag reader portal with a plurality of modular antenna units is provided in according to some example embodiments. The plurality of modular antenna units may comprise a first modular antenna unit and a second modular antenna unit. The first modular antenna unit and the second modular antenna unit may have been manufactured to be substantially structurally identical as interchangeable modules. The example method may comprise mounting the first modular antenna unit via a first universal mounting interface of the first modular antenna unit in a first mounting configuration at 1500. In this regard, the first modular antenna unit may comprise a first antenna having a first antenna read zone. The example method may also comprise, at 1510, mounting the second modular antenna unit via a second universal mounting interface of the second modular antenna unit in a second mounting configuration. The second modular antenna unit may comprise a second antenna having a second antenna read zone. The first antenna read zone and the second antenna read zone may combine to generate one of a plurality of different configurable portal read zones based on positioning and mounting configurations of the first modular antenna unit and the second modular antenna unit. According to some example embodiments, the method may further comprise, at 1520, installing a reader in the first modular antenna unit by accessing a reader compartment of the first modular antenna unit via a side opening in a housing of the first modular antenna unit, and, at 1530, connecting the second antenna to the reader in the first modular antenna unit.

A modular antenna unit is described according to some example embodiments. The modular antenna unit may be configured to read radio frequency tags, and the modular antenna unit may comprise a housing, an antenna, a reader mounting interface, and a universal mounting interface. The housing may comprise an antenna compartment and a reader compartment. The antenna may be affixed within the antenna compartment, and the antenna may have an antenna read zone. The reader mounting interface may be disposed within the reader compartment and may be configured to secure a reader to the housing within the reader compartment for the reader to be connected to the antenna. The universal mounting interface may be configured to mount the modular antenna unit in one of a plurality of mounting configurations. The plurality of mounting configurations may comprise a floor mount configuration, a pole mount configuration, a hang mount configuration, and a stacked configuration. The universal mounting interface may be configured to permit the modular antenna unit to be mounted in the plurality of mounting configurations to allow the antenna read zone to combine with a supplemental antenna read zone of a supplemental modular antenna unit to generate one of a plurality of different configurable portal read zones for a tag reader portal.

Additionally, the universal mounting interface may be configured to affix the modular antenna unit to a universal mounting interface of the supplemental modular antenna unit to being in the stacked configuration, and affix the modular antenna unit to a plurality of different mounting brackets to facilitate mounting in the floor mount configuration, the pole mount configuration, and a hang mount configuration. Additionally or alternatively, the universal mounting interface may comprise a top surface of the housing comprising mounting interface elements and a bottom surface of the housing comprising mounting interface elements. Additionally or alternatively, the reader mounting interface comprises a removable plate to which the reader is affixed. Additionally or alternatively, the housing further comprises a removable rear panel and at least one removable side panel for accessing the reader compartment. Additionally or alternatively, the reader mounting interface comprises a removable reader plate for affixing the reader thereto. The housing further comprises a removable rear panel that covers a rear opening for accessing the reader compartment from behind the housing and a removable side panel that covers a side opening for accessing the reader compartment from a side of the housing. The reader plate may be configured to be detached from the housing via the rear opening and removed from the reader compartment via the side opening. Additionally or alternatively, the housing further comprises a removable rear panel that covers a rear opening for accessing the reader compartment from behind the housing and a removable side panel that covers a side opening for accessing the reader compartment from a side of the housing. The side panel may be removable to gain access to the reader compartment when the modular antenna unit is mounted such that the rear panel cannot be removed. Additionally or alternatively, the antenna may be configured to operate under the control of a supplemental reader installed in the supplemental modular antenna unit when no reader is installed in the modular antenna unit. Additionally or alternatively, a weight and size of the modular antenna unit permits standard parcel shipping. Additionally or alternatively, a weight of the modular antenna unit is less than 20 pounds and a length of the modular antenna unit is less than 40 inches for ease of mobility and modular installation. Additionally or alternatively, the modular antenna unit may be in the floor mount configuration and the supplemental modular antenna unit is affixed to the modular antenna unit in the stacked configuration. In the floor mount configuration, the modular antenna unit may be configured to also support the supplemental modular antenna unit, affixed to the modular antenna unit, in the stacked configuration.

According to some example embodiments, a tag reader portal having a defined portal read zone is described. The tag reader portal may comprise a first modular antenna unit and a second modular antenna unit. The first modular antenna unit may comprise first antenna and a first universal mounting interface. The first antenna may have a first antenna read zone. The second modular antenna unit may comprise a second antenna and a second universal mounting interface. The second antenna may have a second antenna read zone. The first modular antenna unit and the second modular antenna unit may be manufactured to be substantially structurally identical as interchangeable modules. The first universal mounting interface may be configured to mount the first modular antenna unit in one of a plurality of mounting configurations. The plurality of mounting configurations may comprise a floor mount configuration, a pole mount configuration, a hang mount configuration, and a stacked configuration. The first modular antenna unit may be mounted in a first mounting configuration that is one of the plurality of mounting configurations. The second universal mounting interface may be configured to mount the second modular antenna unit in one of the plurality of mounting configurations. The second modular antenna unit may be mounted in a second mounting configuration that is one of the plurality of mounting configurations. The first mounting configuration may be different from the second mounting configuration.

Additionally, the first modular antenna unit may be configured to have a reader mounted therein, and the second modular antenna unit may be configured to have a reader mounted therein. A reader may be mounted within the first modular antenna unit and no reader need be mounted in the second modular antenna unit. The reader mounted in the first modular antenna unit may be connected to and control operation of the first antenna and the second antenna. Additionally or alternatively, the first modular antenna unit may be in the floor mount configuration and the second modular antenna unit may be affixed to the first modular antenna unit while in the stacked configuration.

According to some example embodiments, a method for constructing a tag reader portal with a plurality of modular antenna units is provided. In this regard, the plurality of modular antenna units may comprise a first modular antenna unit and a second modular antenna unit. The first modular antenna unit and the second modular antenna unit may be manufactured to be substantially structurally identical as interchangeable modules. The method may comprise mounting the first modular antenna unit via a first universal mounting interface of the first modular antenna unit in a first mounting configuration. The first modular antenna unit may comprise a first antenna having a first antenna read zone. The method may also comprise mounting the second modular antenna unit via a second universal mounting interface of the second modular antenna unit in a second mounting configuration. The second modular antenna unit may comprise a second antenna having a second antenna read zone. The first antenna read zone and the second antenna read zone may combine to generate one of a plurality of different configurable portal read zones based on positioning and mounting configurations of the first modular antenna unit and the second modular antenna unit.

Additionally, the method may comprise installing a reader in the first modular antenna unit by accessing a reader compartment of the first modular antenna unit via a side opening in a housing of the first modular antenna unit, and connecting the second antenna to the reader in the first modular antenna unit.

Many modifications and other example embodiments in addition to those set forth herein will come to mind to one skilled in the art to which these embodiments pertain having the benefit of the teachings presented in the foregoing descriptions and the associated drawings. Therefore, it is to be understood that the embodiments are not to be limited to those disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A modular antenna unit configured to read radio frequency tags, the modular antenna unit comprising:
a housing comprising an antenna compartment and a reader compartment;
an antenna affixed within the antenna compartment, the antenna having an antenna read zone;
a reader mounting interface disposed within the reader compartment and configured to secure a reader to the housing within the reader compartment for the reader to be connected to the antenna; and
a universal mounting interface configured to mount the modular antenna unit in one of a plurality of mounting configurations, the plurality of mounting configurations comprising a floor mount configuration, a pole mount configuration, a hang mount configuration, and a stacked configuration;
wherein the universal mounting interface is configured to permit the modular antenna unit to be mounted in the plurality of mounting configurations to allow the antenna read zone to combine with a supplemental antenna read zone of a supplemental modular antenna unit to generate one of a plurality of different configurable portal read zones for a tag reader portal.

2. The modular antenna unit of claim 1, wherein the universal mounting interface is configured to:
affix the modular antenna unit to a universal mounting interface of the supplemental modular antenna unit to being in the stacked configuration; and
affix the modular antenna unit to a plurality of different mounting brackets to facilitate mounting in the floor mount configuration, the pole mount configuration, and a hang mount configuration.

3. The modular antenna unit of claim 1, wherein the universal mounting interface comprises a top surface of the housing comprising mounting interface elements and a bottom surface of the housing comprising mounting interface elements.

4. The modular antenna unit of claim 1, wherein the reader mounting interface comprises a removable plate to which the reader is affixed.

5. The modular antenna unit of claim 1, wherein the housing further comprises a removable rear panel and at least one removable side panel for accessing the reader compartment.

6. The modular antenna unit of claim 1, wherein the reader mounting interface comprises a removable reader plate for affixing the reader thereto;
wherein the housing further comprises a removable rear panel that covers a rear opening for accessing the reader compartment from behind the housing and a removable side panel that covers a side opening for accessing the reader compartment from a side of the housing;
wherein the reader plate is configured to be detached from the housing via the rear opening and removed from the reader compartment via the side opening.

7. The modular antenna unit of claim 1, wherein the housing further comprises a removable rear panel that covers a rear opening for accessing the reader compartment from behind the housing and a removable side panel that covers a side opening for accessing the reader compartment from a side of the housing;
wherein the side panel is removable to gain access to the reader compartment when the modular antenna unit is mounted such that the rear panel cannot be removed.

8. The modular antenna unit of claim 1, wherein the antenna is configured to operate under the control of a supplemental reader installed in the supplemental modular antenna unit when no reader is installed in the modular antenna unit.

9. The modular antenna unit of claim 1, wherein a weight and size of the modular antenna unit permits standard parcel shipping.

10. The modular antenna unit of claim 1, wherein a weight of the modular antenna unit is less than 20 pounds and a length of the modular antenna unit is less than 40 inches for ease of mobility and modular installation.

11. The modular antenna unit of claim 1, wherein the modular antenna unit is in the floor mount configuration and the supplemental modular antenna unit is affixed to the modular antenna unit in the stacked configuration;
wherein, in the floor mount configuration, the modular antenna unit is configured to also support the supplemental modular antenna unit, affixed to the modular antenna unit, in the stacked configuration.

12. A tag reader portal having a defined portal read zone, the tag reader portal comprising:
a first modular antenna unit comprising a first antenna and a first universal mounting interface, the first antenna having a first antenna read zone;
a second modular antenna unit comprising a second antenna and a second universal mounting interface, the second antenna having a second antenna read zone;
wherein the first modular antenna unit and the second modular antenna unit are manufactured to be substantially structurally identical as interchangeable modules;
wherein the first universal mounting interface is configured to mount the first modular antenna unit in one of a plurality of mounting configurations, the plurality of mounting configurations comprising a floor mount configuration, a pole mount configuration, a hang mount configuration, and a stacked configuration;
wherein the first modular antenna unit is mounted in a first mounting configuration that is one of the plurality of mounting configurations;
wherein the second universal mounting interface is configured to mount the second modular antenna unit in one of the plurality of mounting configurations;
wherein the second modular antenna unit is mounted in a second mounting configuration that is one of the plurality of mounting configurations;
wherein the first mounting configuration is different from the second mounting configuration.

13. The tag reader portal of claim 11, wherein the first modular antenna unit is configured to have a reader mounted therein;
wherein the second modular antenna unit is configured to have a reader mounted therein;
wherein a reader is mounted within the first modular antenna unit and no reader is mounted in the second modular antenna unit;
wherein the reader mounted in the first modular antenna unit is connected to and controls operation of the first antenna and the second antenna.

14. The tag reader portal of claim 12, wherein the first modular antenna unit is in the floor mount configuration and the second modular antenna unit is affixed to the first modular antenna unit while in the stacked configuration.

15. The tag reader portal of claim 11, wherein the first modular antenna unit comprises:
a housing comprising an antenna compartment and a reader compartment, wherein the first antenna is affixed within the antenna compartment; and
a reader mounting interface disposed within the reader compartment and configured to secure a reader to the housing within the reader compartment for the reader to be connected to the first antenna.

16. The tag reader portal of claim 14, wherein the first universal mounting interface is configured to affix the first modular antenna unit to a plurality of different mounting brackets to facilitate mounting in the floor mount configuration, the pole mount configuration, and a hang mount configuration.

17. The tag reader portal of claim 14, wherein the first universal mounting interface comprises a top surface of the housing comprising mounting interface elements and a bottom surface of the housing comprising mounting interface elements.

18. The tag reader portal of claim 14, wherein the reader mounting interface comprises a removable plate to which the reader is affixed.

19. The tag reader portal of claim 14, wherein the reader mounting interface comprises a removable reader plate for affixing the reader thereto;
wherein the housing further comprises a removable rear panel that covers a rear opening for accessing the reader compartment from behind the housing and a removable side panel that covers a side opening for accessing the reader compartment from a side of the housing;
wherein the reader plate is configured to be detached from the housing via the rear opening and removed from the reader compartment via the side opening.

20. A method for constructing a tag reader portal with a plurality of modular antenna units, the plurality of modular antenna units comprising a first modular antenna unit and a second modular antenna unit, the first modular antenna unit and the second modular antenna unit being manufactured to be substantially structurally identical as interchangeable modules, the method comprising;
mounting the first modular antenna unit via a first universal mounting interface of the first modular antenna unit in a first mounting configuration, the first modular antenna unit comprising a first antenna having a first antenna read zone; and
mounting the second modular antenna unit via a second universal mounting interface of the second modular antenna unit in a second mounting configuration, the second modular antenna unit comprising a second antenna having a second antenna read zone;
wherein the first antenna read zone and the second antenna read zone combine to generate one of a plurality of different configurable portal read zones based on positioning and mounting configurations of the first modular antenna unit and the second modular antenna unit.

21. The method of claim 19 further comprising installing a reader in the first modular antenna unit by accessing a reader compartment of the first modular antenna unit via a side opening in a housing of the first modular antenna unit; and
connecting the second antenna to the reader in the first modular antenna unit.
